(19) United States
(12) Patent Application Publication
(10) Pub. No.: US 2003/0046958 A1
(43) Pub. Date: Mar. 13, 2003

(54) Optical element molding die

(75) Inventors: Yasuhiko Sato, Saitama City (JP); Hiroaki Fujita, Saitama City (JP)

Correspondence Address: JORDAN AND HAMBURG LLP, 122 EAST 42ND STREET, SUITE 4000, NEW YORK, NY, 10168, US

(73) Assignee: Fuji Photo Optical Co., Ltd., Saitama City (JP)

(21) Appl. No.: 10/226,818

(22) Filed: Aug. 23, 2002

(30) Foreign Application Priority Data
Aug. 28, 2001 (JP) 2001-258127

(51) Int. Cl. C03B 11/00

(52) U.S. Cl. 65/305

(57) ABSTRACT

To provide a molding die for molding an optical element by placing an optical material which is heated and softened in a cavity of a molding die provided with a pair of upper and lower molded dies and a blow mold and pressurizing the optical material with the pair of upper and lower molded dies, wherein a lower die provided a transfer surface molded by transferring the transfer surface of the molding matrix to the molded die material is provided, a coefficient of linear expansion of the molded die material made of glass is reduced to the coefficient of linear expansion of the optical material or below and the molding die is designed to meet T₁<T₂<T₃ where T₁ is a glass transition point (Tg) of the optical material, T₂ is a molding heating temperature at the time of molding the optical element and T₃ is a glass transition point (Tg) of the molded die material.

### BACKGROUND OF THE INVENTION

1. Field of the Invention

1. Field of the Invention

The present invention relates to an optical element molding die for manufacturing optical elements.

2. Description of the Related Art

For a molding die for molding an optical material (or glass molded product) by heating and softening an optical element (or glass element) in a heating furnace and then pressing an optical material (or glass material) 10 placed in a cavity of the molding die provided with a blow mold 3 and a pair of upper and lower molded dies using an upper die 2 and a lower die 1, an optical element molding die, at least one of the pair of upper and lower molded dies (upper die 2, lower die 1) of which is molded with a molded die material made of glass is used in recent years (see FIG. 1).

For example, a molding die for manufacturing an optical element requiring an exacting shape and surface quality such as an optical pickup aspheric surface objective lens is required to achieve high accuracy of form and be free of molding variations. There are limitations to a processed form of a molded die manufactured by grinding or polishing a hard metal material. In contrast, a molded die which is molded by heating a molded die material made of glass, applying press-molding thereto using a molding matrix and transferring the molding matrix to the molded die material has a wider degree of freedom in the processed form and is free of variations. Such a technology for manufacturing a molded die through glass molding is known in Japanese Patent Laid-Open No. 2-267129 and Japanese Patent Laid-Open No. 64-33022, etc.

However, in the case where an optical element is molded using a molding die provided with a molded die molded with a molded die material made of glass according to the prior art, when an optical material is heated and pressurized in the molded die and then cooled down to mold an optical element, the mold releasing characteristic of the optical element deteriorates and it is difficult to take the optical element out of the die, causing cracking to occur in the molded optical element.

### SUMMARY OF THE INVENTION

It is an object of the present invention to provide a molding die for molding an optical element provided with a molded die formed with high accuracy of form and free of variations in order to mold an optical element requiring an exacting form and surface quality, capable of preventing deterioration of the mold releasing characteristic of the optical element and preventing cracking of the optical element in the cooling process during molding of the optical element.

In order to attain the above object, the present invention provides a molding die for molding an optical element by placing an optical element which is heated and softened in a cavity of a molded die provided with a pair of upper and lower molded dies and blow mold and pressurizing the optical element with the pair of upper and lower molded dies, wherein a molded die material made of glass is heated and press-molded using a molding matrix, a lower die with a transfer surface which is molded by transferring the transfer surface of the molding matrix to the molded die material is provided, a coefficient of linear expansion of the molded die material made of glass is reduced to the coefficient of linear expansion of the optical material or below and the molding die is designed to meet T₁<T₂<T₃ where T₁ is a glass transition point (Tg) of the optical material, T₂ is a molding heating temperature when molding the optical element and T₃ is a glass transition point (Tg) of the molded die material.

### BRIEF DESCRIPTION OF THE DRAWINGS

FIG. 1 is a cross sectional view of an optical element molding die according to the present invention; and

FIG. 2 is a cross sectional view of a lower die molding die for molding a lower die of the optical element molding die according to the present invention.

### DETAILED DESCRIPTION OF THE PREFERRED EMBODIMENTS

With reference now to the attached drawings, a preferred embodiment of the present invention will be explained below.

In an optical element molding die according to the present invention, at least a lower die 1 is molded with a molded die material 1′.

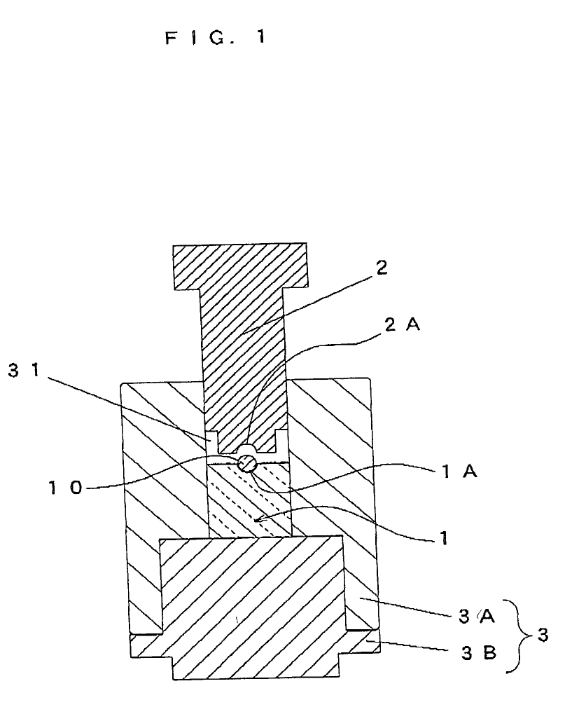

FIG. 1 shows a cross sectional view of a molding die provided with a lower die 1 made of glass. The optical element molding die according to this embodiment is designed to mount an optical material (or glass material) 10 which is heated and softened on a transfer surface 1A of the glass lower die 1 placed in a hole 31 of a blow mold 3, lower the upper die 2 which ascends/descends while sliding inside the hole 31 of the blow mold 3, insert the optical material (or glass material) 10 between the lower die 1 and upper die 2 while heating and pressurizing the optical material, thereby transfer the transfer surface 1A of the lower die land the transfer surface 2A of the upper die 2 to the optical element (or glass material) 10, then cool down the optical element (or glass material) 10 to which the transfer surfaces 1A and 2A have been transferred by heating and pressurization and thereby mold an optical element (or glass molded product).

By the way, the optical element molding die shown in FIG. 1 is provided with the upper die 2 made of solid carbide, but the upper die 2 molded with the molded die material 1′ made of glass can also be used.

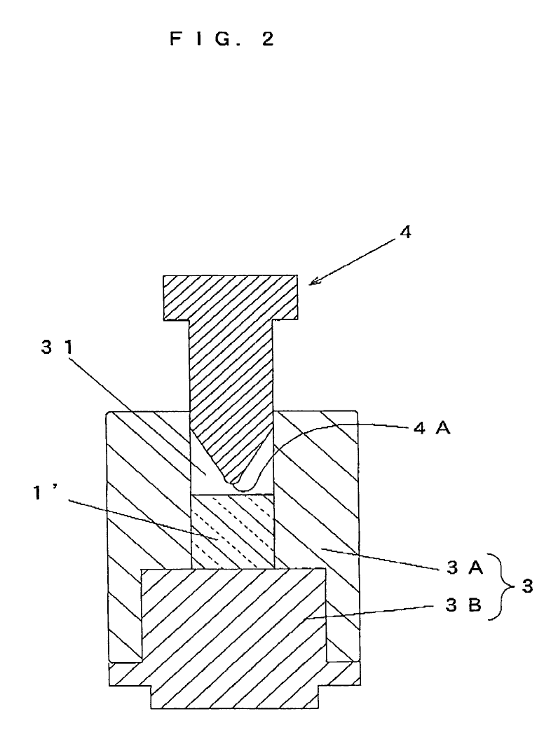

FIG. 2 shows a cross sectional view of a lower die molding die to mold the lower die 1 made of glass. The lower die 1 provided with the transfer surface 1A is molded by placing a molded die material 1′ made of heated and softened glass in the hole 31 of the blow mold 3, lowering the molding matrix 4 which ascends/descends while sliding inside the hole 31 of the blow mold 3, press-molding the molded die material 1′, made of glass using the molding matrix 4 while heating it, transferring the transfer surface 4A of the molding matrix 4 to this molded die material 1′ and then cooling down the molded die material 1′ to which the transfer surface 4A has been transferred by heating and pressurization.

The lower die molding die shown in FIG. 2 uses the molding matrix 4 made of solid carbide.

This embodiment uses the same blow mold 3 for the optical element molding die shown in FIG. 1 and the lower die molding die of the lower die 1 shown in FIG. 2, and the blow mold 3 is constructed of a first member 3A including the hole 31 and a second member 3B that seals the lower opening of the hole 31 and supports the lower die 1 placed inside the hole 31.

Furthermore, the blow mold 3 (first member 3A and second member 3B) is made of a solid carbide material and heating means such as an electric furnace is provided outside the blow mold 3.

When the lower die 1 is molded, the blow mold 3 with the heating means transmits this heat to the molded die material 1′ and press-molds, when the molded die material 1′ made of glass is softened, the molding matrix 4 to mold the lower die 1 on which the transfer surface 1A has been formed. On the other hand, at the time of molding the optical element, the blow mold 3 transmits this heat to the optical material 10 and when the optical material 10 is softened, the upper and lower dies 1 and 2 pressurize the optical material to mold an optical element having transfer surfaces 1A and 2A.

That is, this embodiment molds the glass lower die 1 provided with the transfer surface 1A by transferring the transfer surface 4A of the molding matrix 4 to the molded die material 1′ made of glass inside the hole 31 of the blow mold 3, and then places the optical material 10 on the transfer surface 1A of the glass lower die 1 placed inside the hole 31 of the blow mold 3 using the molding die (from which the molding matrix 4 is removed) using this lower die 1 and blow mold 3, slides the upper die 2 with the transfer surface 2A inside the hole 31, pressurizes the optical material 10 and molds an optical element (or glass molded product) with the transfer surfaces 1A and 2A transferred.

This embodiment has described the case where the upper die 2 and blow mold 3 for molding the optical element shown in FIG. 1 are made of solid carbide, but it is also possible to use ceramics instead of solid carbide. Moreover, the molding matrix 4 and blow mold 3 which are lower die molding dies to mold the glass lower die 1 shown in FIG. 2 are also made of solid carbide, but it is also possible to use ceramics instead of solid carbide.

Furthermore, the optical element molding die according to this embodiment is provided with the lower die 1 (made of glass) molded with the molded die material 1′ made of glass having a coefficient of linear expansion which is equal to or lower than the coefficient of linear expansion of the optical material 10 to be molded and designed to meet T₁<T₂<T₃ where T₁ is a glass transition point (Tg) of the optical material 10, T₂ is a, molding heating temperature when molding the optical element and T₃ is a glass transition point (Tg) of the molded die material 1′.

It is desirable to design to meet (T₃−T₁≧100) so that T₃ which is a glass transition point (Tg) of the molded die material 1′ is higher than T₁ which is a glass transition point (Tg) of the optical material 10 by 100° C. or more.

Using the lower die 1 molded of a glass material having a coefficient of linear expansion which is equal to or smaller than the coefficient of linear expansion of the optical material 10 as the molded die material 1′ made of glass makes it possible to secure, in the cooling process during molding of the optical element, the mold releasing characteristic of the optical element, prevent the optical element accommodated in the transfer surface 1A of the lower die 1 from being embraced and squeezed by the lower die 1 from the periphery and prevent cracking from occurring in the optical element due to pressure from the periphery by the lower die 1.

Furthermore, designing to meet T₁<T₂<T₃ and T₃−T₁≧100 allows the lower die 1 (made of glass) of the optical element molding die to keep optimal hardness without being softened by molding and heating during molding of the optical element and makes it possible to mold an optical element with excellent moldability, high accuracy of form and excellent surface quality.

For example, in the case of an optical element molding die provided with the glass lower die 1 shown in FIG. 1, if the optical material 10 made of glass material PSK100 (hereinafter referred to as “glass material PSK100”) manufactured by Sumita Optical Glass, Inc. is used, heated and pressurized at a molding temperature of 430° C. and molding pressure of 50 kgf to mold an optical element, it is desirable to use the lower die 1 molded with the molded die material 1′ made of glass PBK40 (hereinafter referred to as “glass material PBK40”) manufactured by Sumita Optical Glass, Inc,

Table 1 shows coefficients of linear expansion and glass transition points (Tg) of glass material PSK100 used as the optical material and glass material PBK40 used as the molded die material 1′ of the lower die 1.

TABLE 1

| Name of glass material | Coefficients of | Glass transition |
|---|---|---|
| (manufactured by Sumita | linear expansion | points (Tg) |
| Optical Glass, Inc.) | [x10⁻⁷] | [° C.] |
| PSK100 | 114 | 390 |
| PBK40 | 73 | 501 |
| SFLD21 | 124 | 510 |

In the case where glass material PSK100 is used as the optical element and glass material PBK40 is used as the molded die material 1′, as shown in Table 1, the molded die material (glass material PBK40) has a smaller coefficient of linear expansion than that of the optical material (glass material PSK100) and a relationship of T₁<T₂<T₃ is satisfied between the grass transition point (T₁) of the optical material (glass material PSK100), grass transition point (T₃) of the molded die material (glass material PBK40) and molding heating temperature (T₂) and at the same time the glass transition point of the glass material PBK40 is higher than the glass material PSK100 by 100° C. or more (T₃−T₁≧100), and therefore the optical element molding die provided with the lower die 1 made of the glass material PBK40 has favorable moldability of the optical element and it is possible, in the process of cooling the optical element (glass material PSK100), to prevent the optical element accommodated in the transfer surface 1A of the lower die 1 from being embraced and squeezed by the lower die 1 from the periphery and secure the mold releasing characteristic of the optical element.

Furthermore, when an optical element (glass material PSK100) of φ1.3 μm in diameter and with a lens thickness of 0.4 μm was molded using the optical element molding die provided with the lower die 1 made of glass material PBK40, an optical element with high accuracy of form and excellent surface quality could be successfully molded without any problem such as cracking in the molded optical element.

By the way, when lower die 1 formed of the molded die material 1′ made of glass material SFLD2 manufactured by Sumita Optical Glass, Inc. shown in Table 1 is used (comparative example) for the optical element molding die (FIG. 1) for molding an optical element using glass material PSK100 as the optical element, the molded die material 1′ making up the lower die 1 has a larger coefficient of linear expansion than that of the optical material 10. and as a result, the optical element accommodated inside the transfer surface 1A of the lower die 1 is embraced and squeezed by the lower die 1 from the periphery in the cooling process during molding of the optical element.

Furthermore, when an optical element (glass material PSK100) of φ1.3 μm in diameter and with a lens thickness of 0.4 μm was molded using the optical element molding die (comparative example) with the lower die 1 made of glass material SFLD21, problems like cracking, etc. occurred in 90% of the molded optical elements.

That is, the present invention provides a molding die for molding an optical element by placing an optical material which is heated and softened in a cavity of a molding die provided with a pair of upper and lower molded dies and a blow mold and pressurizing the optical material with the pair of upper and lower molded dies, wherein a lower die molded with a molded die material made of glass is provided, a coefficient of linear expansion of the molded die material made of the above-described glass is reduced to below the coefficient of linear expansion of the optical element and the molding die is designed to meet T₁<T₂<T₃ where T₁ is a glass transition point (Tg) of the optical material, T₂ is a molding heating temperature when forming the optical element and T₃ is a glass transition point (Tg) of the molded die material, and can thereby provide favorable moldability of the optical element, prevent the lower die from squeezing the optical element in the cooing process during molding of the optical element and prevent deterioration of the mold releasing characteristic or cracking of the optical element.

What is claimed is:

1. An optical element molding die that molds an optical element by placing an optical material which is heated and softened in a cavity of a molding die provided with a pair of upper and lower molded dies and a blow mold and pressurizing the optical material with the pair of upper and lower molding dies to mold the optical element, comprising:
a lower die with a transfer surface molded by press-molding a molded die material made of glass using a molding matrix while heating the molded die material and transferring a transfer plane of the molding matrix to said molded die material,
wherein a coefficient of linear expansion of said molded die material made of glass is reduced to the coefficient of linear expansion of the optical material or below and said molding die is designed to meet T₁<T₂<T₃ where T₁ is a glass transition point (Tg) of the optical material, T₂ is a molding heating temperature when molding the optical element and T₃ is a glass transition point (Tg) of the molded die material.

2. The optical element molding die according to claim 1, wherein said molding die is designed to meet T₃−T₁≧100° C.
